(19) United States
(12) Patent Application Publication
(10) Pub. No.: US 2024/0419858 A1
(43) Pub. Date: Dec. 19, 2024

(54) COMPUTATIONAL ACCELERATION OF RADIATION PARTICLE SIMULATION IN A VIRTUAL ENVIRONMENT

(71) Applicant: Lawrence Livermore National Security, LLC, Livermore, CA (US)

(72) Inventors: Ryan Chen, San Jose, CA (US); Bonnie Elise Canion, Oakland, CA (US); Karl E. Nelson, Livermore, CA (US)

(21) Appl. No.: 18/334,276

(22) Filed: Jun. 13, 2023

(51) Int. Cl. G06F 30/20

(52) U.S. Cl. CPC G06F 30/20; G06F 2111/10; G06F 2111/18

(57) ABSTRACT

A simulation system provides real-time, flexible, and accurate simulations of radiological scenarios that can provide robust and valuable training experience to users. A radiological scenario simulation provided by a simulation system includes simulated neutron and gamma measurements provided by a neutron simulation service and a gamma simulation service, respectively. Each of the neutron simulation service and the gamma simulation service perform accelerated computational techniques to provide the simulation results to the radiological scenario simulation in real-time. In particular, the neutron simulation service performs a particle-wise simulation with an optimized number of neutron particles, scales detector objects to an increased size, and models fission behavior for a source object based on simulated neutron particles being scattered back into the source object.

### STATEMENT REGARDING FEDERALLY SPONSORED RESEARCH

This invention was made with Government support under Contract No. DE-AC52-07NA27344 awarded by the United States Department of Energy. The Government has certain rights in the invention.

### TECHNOLOGY FIELD

The present invention generally pertains to simulations of radiation particles and the behaviors thereof within an environment.

### BACKGROUND

Nuclear and radiological emergency responders have a need to prepare and train for nuclear incident scenarios, radiation scenarios, and the like. Challenges exist with generating scenarios and environments that provide productive, useful, and real-time training experience for users. For example, use of a real radiological source for training would be expensive and simply not worth the potential health risks to those involved. Technical solutions that overcome such challenges are needed in the field.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates a diagram of example behaviors and interactions simulated for neutron particles.

FIG. 2 illustrates a diagram of example operations performed to simulate neutron particle dynamics in a service implementation.

FIG. 3 illustrates a diagram of example states in which a simulation service for neutron particle dynamics can operate.

FIG. 4 illustrates a view of example neutron particle dynamics that are simulated.

FIGS. 5A-5C are flow diagrams illustrating examples of processes or techniques implemented by a neutron simulation service that is capable of real-time integration with a radiological scenario simulation.

FIG. 6 is a diagram illustrating an example simulation of gamma ray detection within a specified environment.

FIGS. 7A-7B and FIG. 8 are diagrams illustrating example modeling of gamma ray behavior to provide a simulation of gamma ray detection within a specified environment.

FIG. 9 illustrates a view of an example simulation of gamma ray detection within a specified environment.

FIG. 10 illustrates a diagram of a simulation system that communicates with a neutron simulation service and a gamma-ray simulation service to provide a real-time and flexible simulation of a radiological scenario.

FIGS. 11A-11B illustrate simulated views of example detector objects within a radiological scenario simulation.

FIG. 12 is a diagram illustrating example operations performed by a simulation system and related services or components to provide a real-time and flexible simulation of a radiological scenario.

FIG. 13 is a block diagram illustrating an example of a processing system in which at least some aspects of the technique introduced here can be implemented.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

The present disclosure provides real-time, flexible, and accurate simulations of radiological scenarios that can provide robust and valuable training experience to users. Particular aspects of the present disclosure introduce accelerated and rapid simulations of neutron particle dynamics and gamma ray dynamics that can service a radiological scenario simulation to provide radiological measurements that are reliable and sufficiently real-time. Described herein are technical solutions to handle radiological exposure calculations that incorporate the movement of people, objects, and dynamically changing shielding conditions in real-time.

Example embodiments of the present disclosure address technical challenges experienced with existing technologies for radiological scenario simulations. As discussed above, existing techniques that use real radiological sources expose users to potential radiation exposure and the associated health risks. Other techniques include simulated or virtual radiological sources, but experience respective shortcomings or deficiencies. For example, some processes dictate that trainees during training will take measurements at specific locations in a specific circumstance. The source radiological object cannot be moved or modified in real-time to effect a change in exposure/detector readings. For example, if a trainee wanted to place a lead plate between a detector and a source, the readings (which may be read off a clipboard by an instructor) would not change in an electronic system and would have to be guessed by a subject matter expert onsite. Such existing processes are neither flexible nor real-time solutions.

Some techniques involve sending simulated pulsed data to real detectors in order to fake a radiological source and to drive the detector's response behaviors and user interface. This technique requires mounting custom hardware to a modified detector to achieve the simulation. This technique also relies on differential GPS which in a best case scenario has an accuracy of around 10 cm but cannot be used indoors in GPS denied areas. Other techniques use precomputed meshes to allow a simulated radiation field to report back to the user immediately, but these techniques significantly lack flexibility to reflect changes in the environment. For example, such techniques would require re-computation of meshes to account for a moved object, and dynamically or continuously moving objects would be prohibitive to a continuous real-time simulation.

Example embodiments introduced herein address these and other shortcomings. In one example aspect, the solutions introduced here simulate gamma and neutron radiation interactions within a changeable environment and report out the results in real-time (on the order of seconds) in order to, for example, train personnel. Specifically, aspects of the present technology track radioactive dose to personnel and the readout of several radiation detectors in real time while the people, detectors, source, and other objects move around the room. As the environment changes, the radiation interacts in complex ways that need to be updated to provide an accurate readout for training purposes:
Radiation can be blocked/attenuated by items in the room
Radiation scatters around the environment, losing energy and changing directions, and this behavior needs to be updated as the environment changes
The detector response will change according to the total flux of gammas/neutrons entering the detector, the energy of the radiation, and the direction the radiation enters into the detector; as the detector moves or other items in the room move, the detector behavior needs to update accordingly
The personnel dose is also dependent on the total flux of gammas/neutrons reaching the person, the energy of the radiation, and the direction the radiation enters; therefore dose also needs to be updated according to these parameters
If the source contains fissile material, the source behavior may change as neutrons interact in the environment and are reflected back into the source; these effects are important to train personnel on (particularly for criticality scenarios), and require that the source behavior is updated accordingly.

For neutron simulation, example embodiments leverage Monte-Carlo neutron transport calculations, simplified deterministic models, precomputed empirical models (e.g., including look-up tables), as well as particular techniques for providing the neutron simulation in a flexible and efficient manner that keeps up with the real-time environment. For the gamma-ray simulation, example embodiments can include ray-tracing, simplified deterministic models, precomputed empirical models, and various techniques for accelerating the gamma-ray simulation to reliably service data to the real-time environment. According to the example embodiments introduced herein, a training simulation solution can achieve desired levels of accuracy while also updating the user in a real-time changing environment. The flexibility provided and enabled by the present technology is particularly important to accurate simulate neutron radiation because neutron particles scatter easily and affect the source behavior, which can have major effects on the response.

### Example Embodiments for Neutron Particle Simulation

Techniques described here relate to neutron particle simulation and are designed for accelerated and rapid computing such that simulation outputs can be reliably used for real-time scenario simulations that involve neutron particle behavior. According to example embodiments, example techniques are implemented as a module or service that receives object definition data and returns simulated neutron data to a client. For example, example techniques are implemented as a neutron simulation module, a neutron simulation system, a neutron transport service, a neutron simulation service, or other terms included herein.

In some embodiments, the neutron simulation module is configured to perform Monte Carlo simulations to build up geometries for a target environment, throw neutrons into a target environment, and track the neutrons scattering around the complex geometry of people objects, detector objects and other objects in a target environment. Using Monte Carlo type simulation for an application that needs to provide results in real time with moderate accuracy is counterintuitive because Monte Carlo simulations are known for being computationally demanding and slow (although providing high physical accuracy). According to example embodiments, the neutron simulation module accelerates the Monte Carlo simulation based on the techniques described herein, such that the high accuracy of Monte Carlo simulations in complex environments is leveraged while keeping up with real-time constraints while accelerating the Monte Carlo simulation.

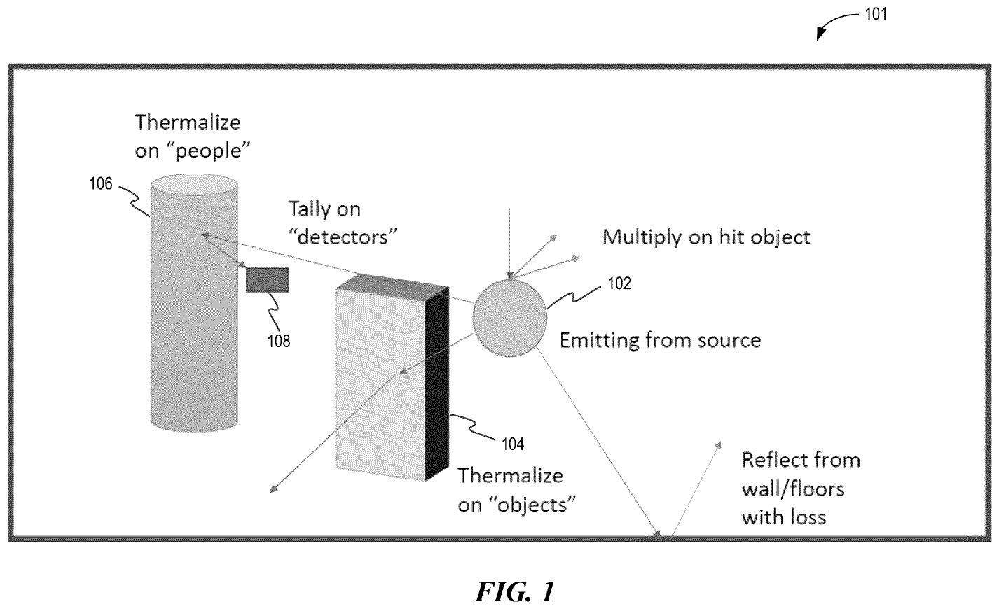

FIG. 1 illustrates a diagram of example behaviors and interactions simulated for neutron particles. In some embodiments, the neutron simulation module simulates a neutron particle within a target environment 101 as being emitted from a source object 102. According to a simulated trajectory of a neutron particle, the neutron simulation module tracks the neutron particle in environmental objects or mobile objects 104 and on people objects 106 that represent users or people located within the target environment 101. For example, after the neutron particle is determined to impact a mobile object 104 or a people object 106, the neutron simulation module adjusts the simulated trajectory and simulated energy of the neutron particle according to an expected and/or precomputed thermalization event/process. The neutron simulation module tallies the neutron particles that are incident on detector objects 108 located within the target environment 101 in order to determine neutron counts and detection data. The neutron simulation module multiples neutron particles that are scattered back into the source object 102, to represent fission chains accordingly. The neutron simulation module reflects (e.g., adjusts trajectory and energy according to a reflection) neutron particles from walls and floors of the target environment 101 with loss. Locations, sizes, and other properties or characteristics of the objects and the target environment 101 can be provided to the neutron simulation module as initialization data, for example, according to a radiological scenario simulation with the objects within the target environment 101.

Techniques for accelerating a particle-wise simulation (e.g., a Monte Carlo simulation) in complex environments such as that shown in FIG. 1 include the following. By implementing at least some of the following techniques, a simulation time can be sped up to satisfy real-time performance constraints.
The source object 102 can be reduced to a precomputed sphere or geometry that emits neutrons with a given (e.g., specified) intensity and energy distribution. Thus, a radiation source can be computed in vacuum ahead of a simulation performed by the neutron simulation module, and the neutron simulation module can be provided with a specified neutron flux to sample.
Further, the neutron simulation module can use a fission chain model to sample the number of neutrons released following a neutron being scattered back into the source object (induced fission chain). In some embodiments, the fission chain model is a point kinetics model. In some embodiments, the fission chain model is an empirical model. The point kinetics model for fission chain can be used when accuracy is desired, while the empirical model can be used to favor computational speed and efficiency. Multiplication is based on the specified parameters defined for the source object, including an effective neutron multiplication factor (“Keff”) (probability of neutron inducing further fission), multiplicity (number of neutrons produced on average per fission), and radius (surface defined as locations where neutron may scatter back into the source, potentially leading to further fissions, and raising the multiplication of the system in the reflection rate near the source is increased). An example source object can be specified with various parameters; for example, the neutron simulation modules can define, from specified parameters, a one-kilogram sphere of ²³⁹Pu (some alpha-n source added), with a fissline_nuclide parameter set to “Pu-239,” a Keff parameter set to 0.4513, a radius parameter set to 0.023, a multiplicity parameter set to 3.04, and a sourceRate parameter set to 51350 [neutrons/second].
Certain environmental objects of the target environment, such as the floor and walls and other movable scattering objects, can be precomputed absorbing/scattering media. A neutron can enter a given one of the certain environmental objects and the neutron simulation module uses a precomputed probability that the neutron exits the given object with a precomputed loss of energy and a precomputed change of direction. Thus, the neutron simulation module can replace environmental objects with empirical models of neutron absorption/scattering/energy loss. With precomputed empirical models, the neutron simulation module can flexibly adjust and account for movement and updated locations of the environmental objects. For example, the neutron simulation module can apply a precomputed empirical model for a respective object at different specific locations over time.
The neutron simulation module can increase the volume or size of detector objects to artificially enhance the neutron flux reaching it. In particular, the neutron simulation module scales up the size of a detector object and then rejects some neutron flux to get proper statistics. In an illustrative non-limiting example, consider a scenario in which a specified source flux is 50k neutrons per second in the room, but the neutron simulation module only got 10k to simulate in the time (due to the load on the CPU). Neutron tallies on the detector would not be accurate given the reduced number of neutrons that are simulated. In the same illustrative example, assume the detector is scaled up with 100× the volume when simulating the 10k neutrons. For each neutron that hits the detector, the neutron simulation module randomly rolls a probability (e.g., 5/100 or 5%, corresponding to the rate correction divided by scale up). The neutron continues regardless. Accordingly, a small number of neutrons that interact with the detector object may not change the dose total and gives correct statistics for detector neutron counts. In some embodiments, the neutron simulation module handles scenarios in which the simulated statistics fall below the scenario statistics. In another illustrative non-limiting example, in which the neutron simulation module implements the above-described techniques for detector object scaling, consider a specified source flux of 500k neutrons per second and an actual simulated flux of 5k neutrons per second. The volume corrector factor (for the detector object) would be 50 times, resulting in a 100/50 or 200% chance probability that is evaluated for each neutron that hits the scaled detector object. In such scenarios (where the evaluation probability exceeds 100% or another threshold probability), the neutron simulation module samples from the source distribution to fill in missing counts towards the statistics. Accordingly, in some embodiments, the neutron simulation module determines whether to scale detector objects based on whether a resulting evaluation probability for neutron hits would exceed a threshold probability.
Further, the neutron simulation module replaces neutron transport in detector objects with an empirical model of the direction-dependent, energy-dependent efficiency curve for the detector. In particular, an efficiency of the detector (and its output) is a function of both direction and energy of incident neutrons.

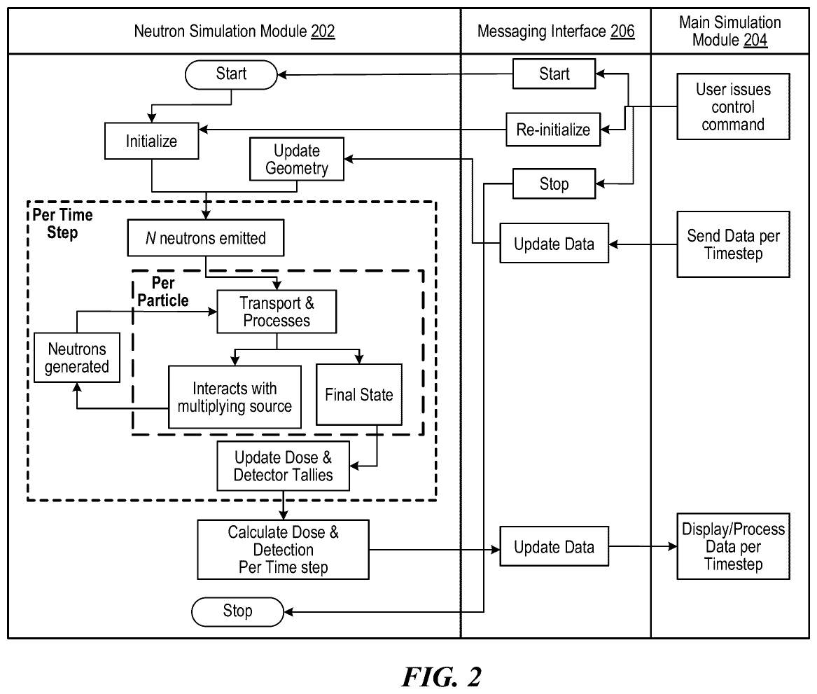

FIG. 2 illustrates a diagram of example operations performed to simulate neutron particle dynamics in a service implementation. For example, a neutron simulation module 202 implements a service, an interface (e.g., an application programming interface), or the like via which a client, such as a main simulation module 204 or main simulation engine that provides a radiological scenario simulation, can request and receive simulated neutron data. Simulated data provided by the neutron simulation module to its client can include, for each of a number of time slices, neutron counts in detector objects and a total dose (e.g., a neutron dose, a dose with respect to neutron energy deposited into a person) in each specified people object, as well as other data and metadata about all objects and sources in the simulation (e.g. location, source multiplication, neutron data passed to the gamma-simulation engine for its calculations, etc.). In some embodiments, the neutron simulation module 202 and the main simulation module 204 communicate with one another via a messaging interface 206 or a messaging library (e.g., a ZeroMQ library or system).

An example sequence of events includes the following:
Start program: the main simulation module 204 sends definitions of source object(s), people object(s), environmental object(s), and detector object(s) to the neutron simulation module 202.
Initialize: the main simulation module 204 sends an initialize command to the neutron simulation module 202.
Update: the main simulation module 204 provides spatial data describing positions of the objects within the target environment to the neutron simulation module 202. The neutron simulation module 202 can update object positions (e.g., from a previous position) according to the spatial data, while checking for overlap and adjusting positions if needed.
Run: the main simulation module 204 sends a run or execute command to the neutron simulation module 202. The neutron simulation module 202 simulates a particular number of neutrons being emitted from the source object. In some embodiments, the neutron simulation module 202 simulates the maximum number of neutrons that it can simulate while satisfying a real-time performance constraint (e.g., 500 milliseconds, 1 second, 2 seconds). Accordingly, the particular number of neutrons actually simulated can be less than or greater than the modeled source neutron flux for the source object by a scaling factor.

During simulation, neutrons are scattered, lost, or induce further fission from the source, and the neutron simulation module 202 tallies neutron flux for detector objects and people objects. After transport is complete, tallies are processed to determine detected neutrons (e.g., detection data) and/or dose to people (e.g., dosage data), applying scaling factors for realistic (and/or specified) source rates.
Broadcast: At end of run, the neutron simulation module 202 can broadcast the simulated data, for example, back to the main simulation module 204 and/or other modules (e.g., a gamma ray simulation module). The simulated data that is broadcast by the neutron simulation module 202 can include detection data, neutron flux (to pass to the gamma ray simulation module for neutron-gamma covariant signatures), dosage data, source behavior data, and the like. Additionally, based on the amount of time the simulation took, the neutron simulation module 202 can update its predictions for how many neutrons to simulate in one second or a real-time constraint.

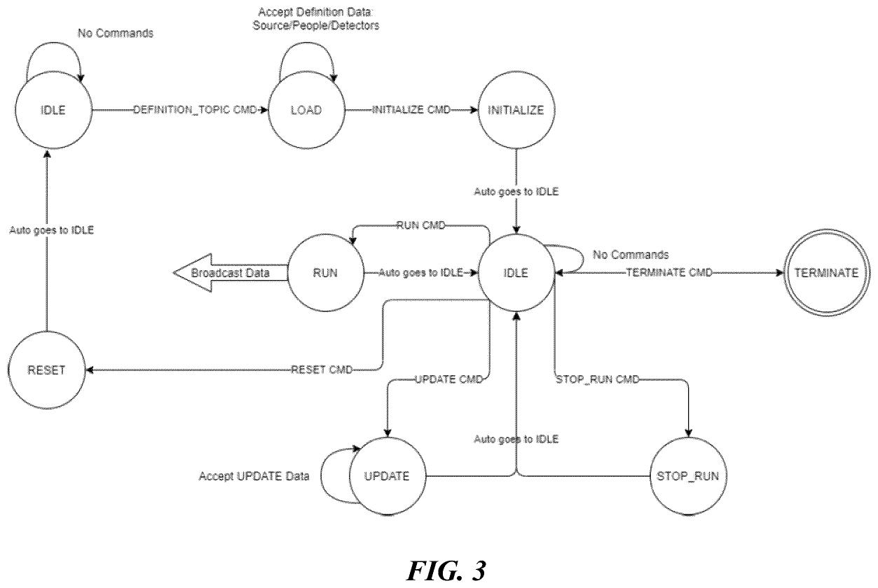

FIG. 3 illustrates a state diagram that demonstrates an example operation of a neutron simulation service. In some embodiments, the operation of the neutron simulation service follows a state machine structure. In some embodiments, the neutron simulation service traverses through the state machine structure in response to input commands, for example, commands received from a main simulation server/engine, commands input by a user, and/or the like. In some embodiments, the states can include:
IDLE: Default state. In the IDLE state, the program is waiting for new commands.
LOAD: The neutron simulation module 202 needs to enter into the LOAD state first before it goes into the INITIALIZE state. In the LOAD state, the neutron simulation module 202 accepts all incoming definitions data for new people, detectors, sources, and other objects in the scene.
INITIALIZE: After the definitions of the people/source/detectors have been sent, the neutron simulation module 202 shall be initialized to build the world.
RUN: Initialization must occur before run according to the example state machine. The RUN state will run 1 second, simulate the neutron source, detection, and dose of neutrons and broadcast the results. After the 1 second, the neutron simulation module 202 will return to IDLE and wait.
UPDATE: In the UPDATE state, the state machine accepts incoming update data.

Any data sent in this state will be treated as update data. As discussed, the neutron simulation module 202 is adapted to provide flexible neutron simulation, in which precomputed empirical neutron behavior models for objects can be flexibly adapted or correlated with updated locations of the objects. Updated spatial data accepted by the neutron simulation module can include new coordinates in a three-dimensional space, as well as rotational parameters for orientation of an object.
RESET: Reset the state machine and allows user to go back to the LOAD state to define new objects (people/sources/detectors/shields)—requires that the user initializes the program again after all LOAD data sent to program. In some embodiments, the RESET state enables definition of new objects within the target environment. In some embodiments, the neutron simulation module 202 is configured to dynamically update the simulation and/or environment according to definitions of new objects that the neutron simulation module 202 receives (e.g., via user input, via object tracking systems that detect new real-world objects in the environment).
STOP_RUN: Goes to Idle state.
TERMINATE: Ends program
REQUEST_TYPES: Request that a list of options be broadcast. Will go into LOAD state during broadcasting, and then return to IDLE state.
REQUEST_MATERIAL_TYPES: this will lead to a series of broadcasts from the program detailing the scattering materials that are available for modeling. This dictates which empirical models to select, e.g. for modeling floor scattering effects. Empirical models generated and stored by the system are associated with material types and can be selected according to material type.

While FIG. 3 illustrates one example of a state machine implemented in the operation of the neutron simulation module 202, it will be understood that various alternatives of the state machine can be implemented for the neutron simulation module 202. For example, an alternative state machine for the neutron simulation module does not include the RESET state.

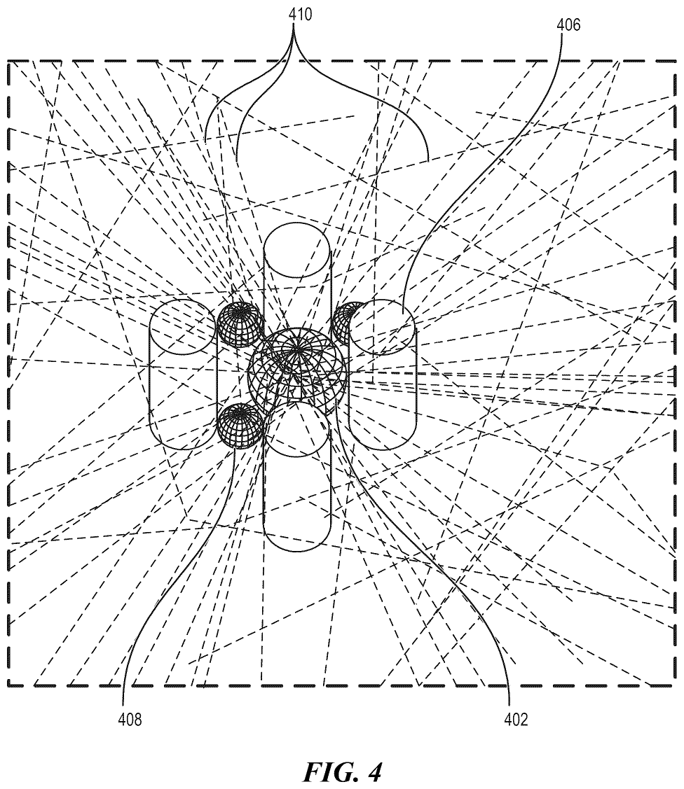

FIG. 4 illustrates a view of example neutron particle dynamics that are simulated by the neutron simulation module. As shown by the neutron tracks 410, the neutron simulation module determines various behaviors, interactions, and dynamics of neutron particles with other objects, including people objects 406, detector objects 408, and source objects 402. At least some of the objects are replaced with precomputed empirical models. Thus, instead of modeling discrete interactions as a neutron transports through an object, the precomputed empirical model simply provides a displaced location and an attenuated energy. Accordingly, example embodiments realize technical improvements over existing technologies based on adapting Monte Carlo simulation with precomputed/empirical modeling approaches to balance speed and physical accuracy, thus simplifying or abstracting neutron tracking within an object. As described herein, example embodiments can also throw less particles and scale dosage/detections at source rate, as well as enlarge low-efficiency neutron detectors to account for lowered statistics (e.g., approximating true detector size).

To run the simulation, the neutron simulation module can receive object definitions. In some embodiments, the neutron simulation module can define and establish a coordinate system with respect to which objects can be dynamically positioned or arranged. According to the coordinate system, the neutron simulation module can arrange detector objects to “point” along the Z+ axis or a pre-defined default orientation. In some embodiments, the neutron simulation module receives specific starting rotational parameters for detector orientation. In some embodiments, the objects in the target environment will be checked against the bounds or dimensions of the target environment before each updated movement, and may not be allowed to overlap or leave the space. In some embodiments, the neutron simulation module is initialized with a spatial orientation or coordinate system that is aligned with one used by other simulation modules (e.g., a gamma simulation module, an optical tracking system, a main simulation module).

The purpose of the detector model is to replicate the rates seen in real detector systems. The detector object does not contain any material and do not simulate any interactions or tracking. The detector object or detector model tracks neutrons entering its volume, and samples directionally-dependent and energy-dependent efficiency curves to simulate detection behavior. As described herein, the detector volume is also increased artificially to gain better statistics. For each event, the neutron simulation module tracks the information of all particles entering the detector object. This detection information can include time (to ensure the particle was not delayed beyond the current collection time), energy (so that the neutrons can be histogrammed to apply an energy-dependent efficiency function), and momentum direction (phi and theta) (so that the direction of the particle relative to the detector orientation can be used to determine the directionally-dependent efficiency function).

In some embodiments, different efficiency and detection curves are stored for different models and types of detectors, and the neutron simulation module receives a specified model/type of a detector object, from which the neutron simulation module applies the corresponding efficiency/detection curve.

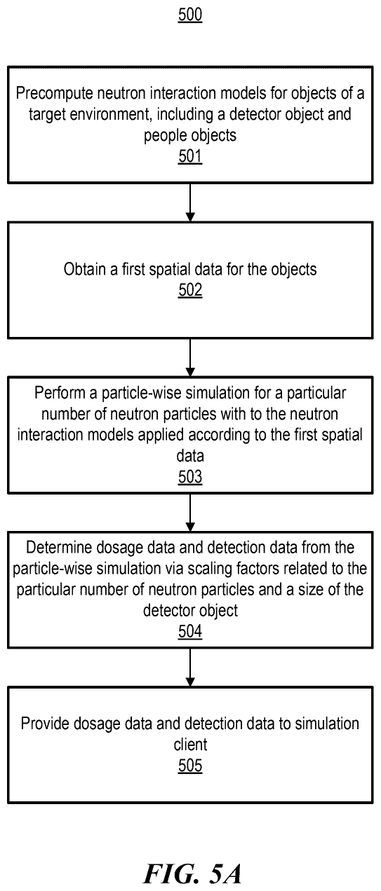

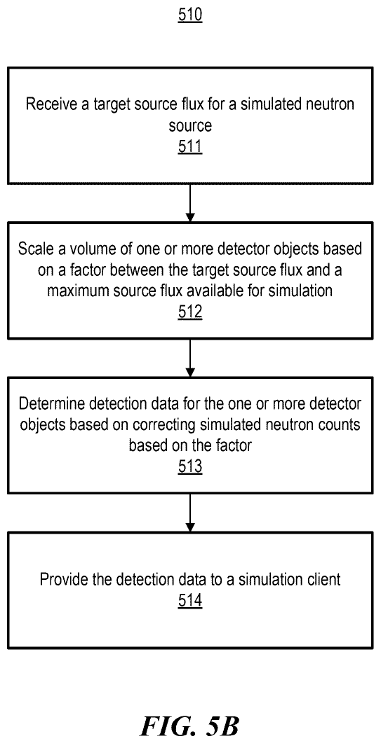

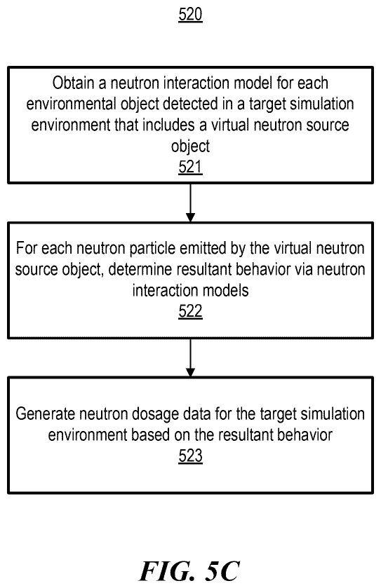

FIG. 5A illustrates an example of a process 500 that can be performed according to example embodiments described herein. In particular, the process 500 is implemented by a neutron simulation service. At 501, the neutron simulation service generates a plurality of neutron interaction models for a set of objects of a target environment. A given neutron interaction model of the plurality of neutron interaction models provides a resultant behavior of an incident neutron with a respective object based on expected interactions between the incident neutron and an internal volume of the respective object. The set of objects includes environmental objects, a person, a detector object, and a radiation source object.

At 502, the neutron simulation service obtains first spatial data for a target environment. The first spatial data specifies first locations of the set of objects within the target environment. In some embodiments, the first spatial data is pre-loaded to the neutron simulation service. In some embodiments, the neutron simulation service is configured to continuously receive spatial data when performing a simulation and continuously update the locations of objects within the target environment based on the continuously received spatial data.

At 503, the neutron simulation service performs a Monte Carlo simulation in which a particular number of neutron particles originate from the radiation source object and interact with the set of objects according to the neutron interaction models and the first spatial data. The particular number is less than a specified number of neutron particles associated with the radiation source object by a first scaling factor, and performing the Monte Carlo simulation includes increasing a simulated size of the detector object by a second scaling factor such that an increased amount of neutron particles interact with the detector object in the Monte Carlo simulation.

At 504, the neutron simulation service calculates dosage data for the person and detection data for the detector object via the Monte Carlo simulation. Each of the dosage data and the detection data is adjusted from a simulation output data according to the first scaling factor. The detection data is further adjusted from the simulation output data according to the second scaling factor.

At 505, the neutron simulation service provides the dosage data and the detection data to a main simulation engine that provides an interactive extended reality (XR) simulation with the set of objects within the target environment.

FIG. 5B illustrates an example of a process 510 or technique that can be performed according to example embodiments described herein. In particular, the process 510 is implemented by a neutron simulation service to handle computational constraints on complete neutron source flux simulation.

At 511, the neutron simulation service receives a target source flux for a simulated neutron source. In some embodiments, the target source flux is a pre-specified or pre-determined flux parameter associated with a pre-defined neutron source virtual object. In some embodiments, the target source flux is defined by a user for a radiological scenario simulation.

At 512, the neutron simulation service scales a volume of one or more detector objects in a virtual simulation with the simulated neutron source. The neutron simulation service scales the detector volume based on a factor between the target source flux and a maximum source flux available for simulation. For example, the neutron simulation service simulates a source flux less than the target source flux due to real-time constraints or pre-determined constraints on computational resource consumption by the neutron simulation service. In some embodiments, the neutron simulation service retroactively scales the detector objects after simulated the maximum source flux. In some embodiments, the neutron simulation service predicts the maximum source flux that is available for simulation and scales the detector objects prior to simulating the maximum source flux from the simulated neutron source.

At 513, the neutron simulation service determines detection data for the one or more detector objects based on correcting simulated neutron counts based on the factor. The detection data includes neutron counts and neutron dosage data that is first determined by the neutron simulation service based on a number of neutron particles (when simulating the maximum source flux) that impact or interact with the scaled volume of the detector objects. The neutron simulation service then corrects this number of neutron particles based on the factor by which the detector object volumes are scaled. For example, as described herein, the neutron simulation service evaluates a probability based on the factor for each impacted neutron particle to determine whether to include the impacted neutron particle in a final neutron count or neutron dosage data.

At 514, the neutron simulation service provides the detection data to a simulation client, such as a main simulation engine providing a virtual simulation involving the simulated neutron source and the detector objects.

FIG. 5C illustrates an example of a process 520 or technique that can be performed according to example embodiments described herein. In particular, the process 520 is implemented by a neutron simulation service to accelerate the simulation of neutron dynamics and interactions with absorbing/scattering/reflecting media.

At 521, the neutron simulation service obtains a neutron interaction model for each environmental object detected in a target simulation environment that includes a virtual neutron source object. The environmental objects include absorbing/scattering/reflecting media of various materials, thus causing different resultant behavior in neutrons impacted therewith. The neutron interaction model for an environmental object is precomputed. In some embodiments, the environmental objects are detected based on object tracking/sensing systems located at the target simulation environment.

At 522, the neutron simulation service determines resultant behavior, including trajectories and energies (attenuations), for each virtual neutron particle emitted by the virtual neutron source object based on evaluating the neutron interaction model for each environmental object upon which the virtual neutron particle is incident. In this manner, the neutron simulation service efficiently simulates behavior of a plurality of virtual neutron particles emitted by the virtual neutron source object, without simulating particle-level interactions (e.g., reflections) within an environmental object. For example, the neutron interaction model for a given environmental object can simply provide a precomputed exit trajectory and a precomputed exit energy for a given neutron incident upon the given environment object at a particular entry trajectory and a particular entry energy.

At 523, the neutron simulation service generates neutron dosage data for the target simulation environment based on simulating the resultant behavior of neutron particles for a simulation time period. In some embodiments, the neutron dosage data is specific to a particular location or point within the target simulation environment and is based on a number and energy of neutrons that, according to resultant behavior with environmental objects in the environment, traverse through the location or point. The neutron dosage data can thus be simulated for a person located at the location or point within the target simulation environment. By using the neutron interaction model to streamline simulation of neutron particle dynamics, the neutron dosage data can be determined by the neutron simulation service in an efficient manner and within real-time performance constraints. Accordingly, the neutron simulation service can further provide the neutron dosage data to a client simulation or a higher-level simulation program.

### Example Embodiments for Gamma Ray Simulation

Techniques described here relate to rapid simulation of gamma ray transportation to provide rapid estimation of detector response for a source encounter. According to example embodiments, example techniques for gamma ray simulation are implemented as a module or service that receives object definition data and returns simulated detection data to a client. For example, example techniques are implemented as a gamma simulation module, a gamma simulation service, or other term included herein. In some embodiments, the gamma simulation module/service includes an application programming interface (API) that can be called by other modules or systems, for example, a main simulation module that provides a radiological scenario simulation. For example, the gamma simulation module/service can return gamma decay energy spectra, gamma detection data, data describing fission gamma-rays, and data describing neutron-induced gamma rays. At least some of the information output/provided by the gamma simulation module/service can be derived from the information output/provided by the neutron simulation module/service.

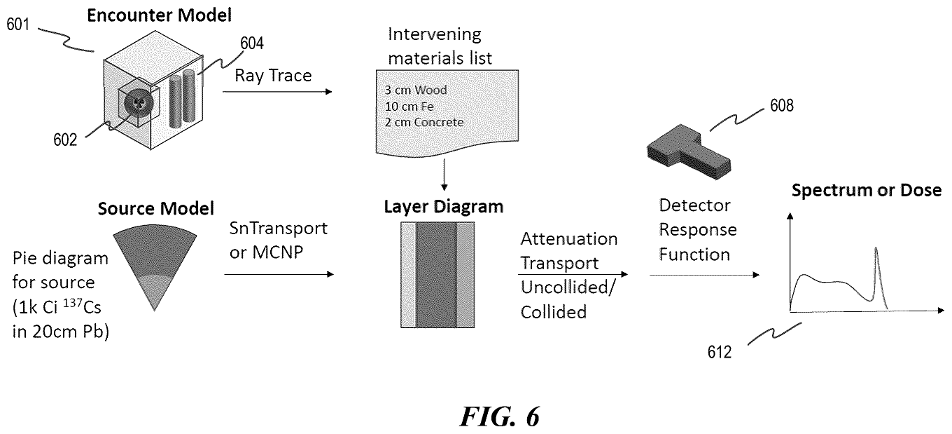

FIG. 6 illustrates a diagram in which a gamma simulation module simulates and provides gamma detection data 612 related to a target environment 601 in which a source object 602 and environmental objects 604 (and/or other objects) are located. In some example scenarios, the source object 602 is hidden and/or has large shielding in the near field, and there are intervening materials (e.g., environmental objects 604, people objects (not shown)) that block the source object 602 depending on the position. According to the example embodiment illustrated in FIG. 6, the gamma simulation module performs a ray trace on gamma rays simulated as originating from the source object 602 and colliding with intervening objects before reaching a detector object 608. The gamma detection data 612 reflects attenuation and transport of the simulated gamma rays to the detector object 608.

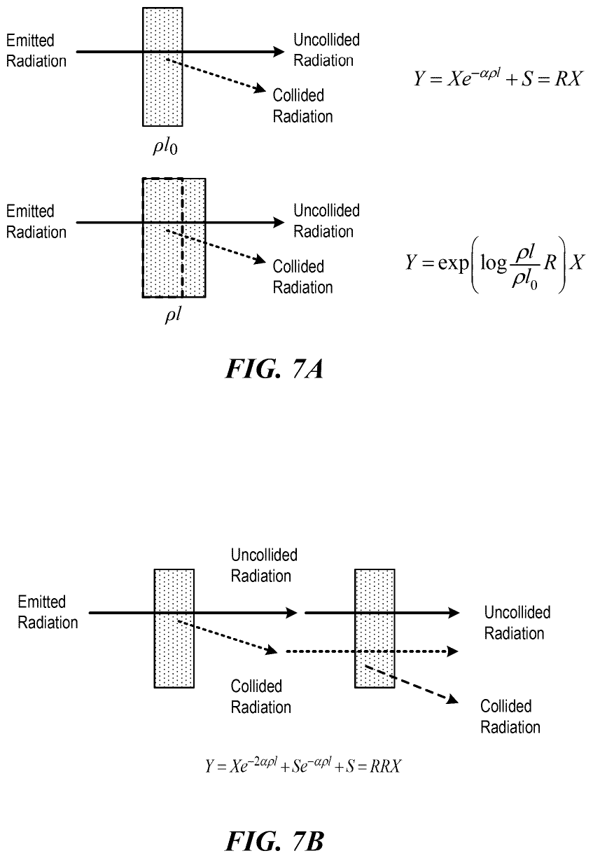

FIGS. 7A-7B illustrate diagrams that show precomputed and/or empirical models of attenuators for gamma rays, which are used by the gamma simulation module to determine gamma detection data. With the example models and techniques, the gamma simulation module is able to provide gamma detection data in real-time, thus providing a technical improvement over existing approaches. In FIG. 7A, the response of a gamma ray to an attenuator is precomputed, and an attenuator model can be defined and generalized based on the matrix exponential of the transfer equation. Accordingly, the gamma ray response can be computed, in some examples, in less than 10 milliseconds. FIG. 7B demonstrates that multiple shielding layers can be applied in succession to estimate even reasonably complex scenarios with multiple or thicker intervening objects.

The gamma simulation module can represent flux as line sources (uncollided direct emissions) and groups (scattered radiation). An attenuator directly attenuates as a function of energy; thus, the gamma simulation module can compute the loss in line and groups directly. The gamma simulation module can then compute the amount of secondary attenuation by transferring through the Padé approximate of the response matrix R, as shown in Equation 1 below. Accordingly, the gamma simulation module provides a result that includes both direct and indirect contributions, but already accounting for the direct calculation (with better accuracy). The gamma simulation module can adjust the scattering by the ratio of the matrix calculation and the direct contribution to sew the two outputs together.

$$T = {( I + \frac{( uR )}{2} - \frac{{( uR )}^{2}}{9} + \frac{{( uR )}^{3}}{72} - \frac{{( uR )}^{4}}{1008} - \frac{{( uR )}^{5}}{30240} )}^{- 1} ( I + \frac{( uR )}{2} + \frac{{( uR )}^{2}}{9} + \frac{{( uR )}^{3}}{72} + \frac{{( uR )}^{4}}{1008} + \frac{{( uR )}^{5}}{30240} \qquad Equation 1$$

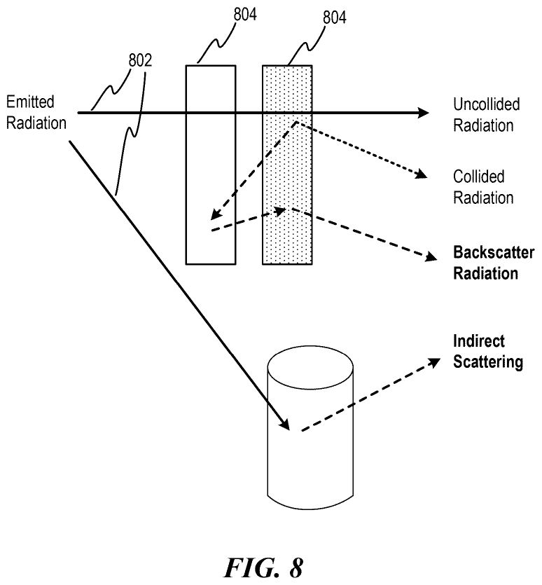

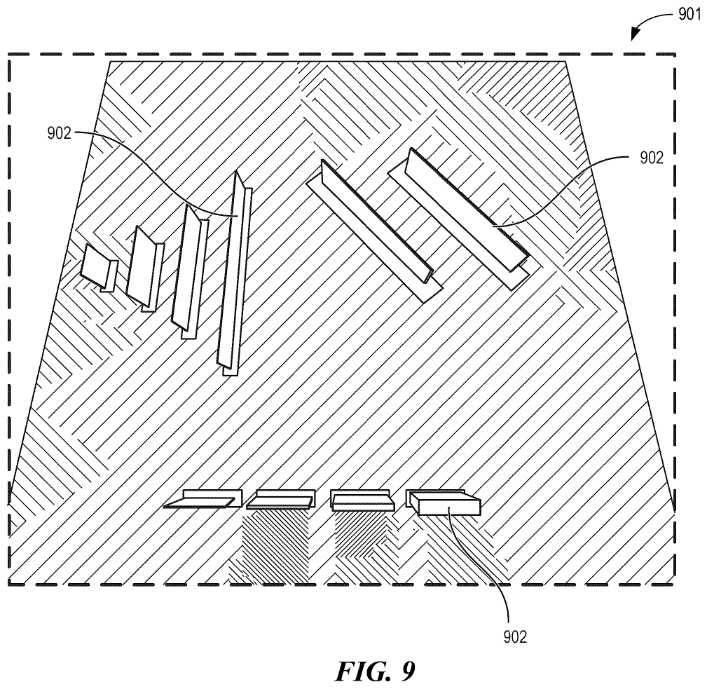

FIG. 8 illustrates a diagram that shows different paths or behaviors of gamma rays 802 with intervening objects 804, at least some of which are accounted for and captured by the gamma simulation module. The gamma simulation module captures all of the emissions that travel in the direction from the source to the detector and thus most of what the user will see. In some embodiments, the gamma simulation module can additionally capture effects such as radiation that scatters back from intervening materials or from indirect paths. In some embodiments, the gamma simulation module can elect to not capture these more complicated affects; fortunately, highly scattered radiation does not have any spectral shape and thus is just a meaningless continuum of energy. Thus it does not meaningfully change the instrument response. For scenarios where indirect scattering is dominate (cracked pig), the gamma simulation module can use a separate calculation to add this effect.

Thus, the gamma simulation module can provide gamma detection data in real-time based on techniques such as using matrix approximation and exponentiation (extrapolated from offline calculations) to provide excellent accuracy on instrument response. Source configurations and attenuation coefficients can be precomputed offline. Other effects such as strong Compton scattering can be added individually using a separate ray trace from the beam to the scatter material and then to the detector.

When implemented as an interfaced service, the gamma simulation module can receive an input that includes source definition data, source distance (e.g., from detector), and shielding information (e.g., tracked environmental and/or mobile objects, people objects). The gamma simulation module can return an output that includes gamma dose, gamma counts (spectra), and total gamma counts (finder).

FIG. 9 illustrates an example of a gamma dose map 901 that the gamma simulation module can simulate and provide. The gamma dose map visualizes gamma counts within a target environment in which various objects 902 are located. To provide the gamma dose map 901 or other gamma simulation/detection data, the gamma simulation module can perform a real-time calculation of intervening layers or objects 902 located within the target environment, via the following process.
1. A ray is cast from the source to a proxy object that gets instantiated at the beginning of the intervening layer calculation. The proxy object has a collider with the tag “detector” (if the calculation is for a detector) or “trainee” (if the calculation is for a person). Intervening layers can be entirely virtual or tracked real-world objects that drive the location and orientation of virtual representations.
2. If the first object hit by the ray has the tag “detector” or “trainee”, then the calculation stops, and it is determined that there are no intervening layer between the source and the specific detector/trainee. However, if the first object hit has the tag “water”, “wood”, “iron”, or “lead” then the following process starts and repeats until a ray hits the specific object with the tag “detector” or “trainee.”
a. When a ray is cast from the source and hits a marked intervening layer with a specific material type, all the marked intervening layers are turned off except the layer that was struck (layer 1). This first contact point is designated “A”.
b. A ray is then cast from the proxy object (toward the source). When it strikes layer 1, a second contact point is recorded, “B”.
c. The distance between “A” and “B” provides the thickness of the intervening layer and this information is saved along with the material type (water, wood, iron, lead).
d. All the intervening layers are then turned back on, and a new ray is cast from point “B” toward the proxy object. If the ray strikes a designated intervening layer, the thickness calculation steps repeat. If the ray strikes the marked “detector/trainee” proxy, then the calculation ends, the gamma request gets assembled with the list of shielding layers defined, and the gamma simulation module takes this information and produces a context-specific output.
   Example Implementations with Radiological Scenario Simulation/Training

Example embodiments described here relate to systems and methods for providing radiological scenario simulations that integrate real-time and accurate neutron and gamma simulations, for example, via other example embodiments described herein. According to example embodiments, a radiological scenario simulation is provided in a virtual extended reality (XR) environment with virtual objects, some of which corresponding to and flexible according to real-world objects (e.g., people, boxes and walls, a detector). As used herein, extended reality can refer to augmented reality (AR), virtual reality (VR), mixed reality (MR), and similar technologies in which virtual constructs in combination with a real-world environment are provided for a user to experience (e.g., visually via an XR display device, such as a headset). In some embodiments, an example system that provides radiological scenario simulations implements an XR engine, a gaming engine, and/or other engines, modules, or systems that generate, update, maintain, and execute a virtual XR environment.

Accordingly, the present disclosure can provide a realistic real-time training application, and example embodiment integrate the disclosed technology relating to neutron simulation and gamma simulation with the realistic real-time training application. Example embodiments can create custom training scenarios, such that trainees or administrators do not need to rely on pre-calculated data with pre-determined survey locations. In some embodiments, a simulation system utilizes submillimeter accurate optical positional tracking technology to track and update the training scenario, these tracking and updates caused responsive changes in simulated neutron and gamma measurements to drive informed decision-making by the trainee. In some embodiments, the simulation system includes a library of source-terms to address the cost and logistical burden of training with real sources, and options for customizing the Item of Primary Concern (IPC) so that the shielding from intervening layers is properly accounted for in the radiation transport for accurate energy dependent simulated detector response.

According to example embodiments, a simulation system providing radiological scenario simulations with real-time neutron simulation and real-time gamma simulation includes at least the following features:
1. The ability to dynamically calculate both gamma and neutron exposure base on the real-time position of the detector, the source (or item of primary concern: IPC), and number of intervening layers between the two (using a custom function that uses ray-casts to calculate the thicknesses of each layer and identifies the material type to determine the areal density). For example, the simulation system includes or is communicatively coupled with a neutron simulation system, as described herein, and a gamma simulation system, as described herein.
2. The ability to dynamically select from a list of virtual sources and to begin training within minutes of loading the application.
3. The advantages of the optical tracking system used by the simulation system allows for highly accurate location and orientation tracking as well as the ability to track multiple detector and trainees simultaneously with each person receiving a real-time radiological dose calculation. This allows entire responder teams to training and work together as they would in a real scenario.
4. The simulation system includes mobile user devices (e.g., smartphone devices, tablet devices, laptop devices, media player devices, handheld devices) to serve as proxy compute units for real detectors. This mimics the look and feel of a real detector on relatively inexpensive smartphones keeps the costs low for the response community.
5. The simulation system only uses a local encrypted local area network (e.g., a Wi-Fi network) for communicating with the connected mobile devices running the custom detector applications and/or other computing devices among which simulation computations can be distributed. All data packets transmitted wirelessly are themselves serialized and encrypted can only be read by the custom detector applications.

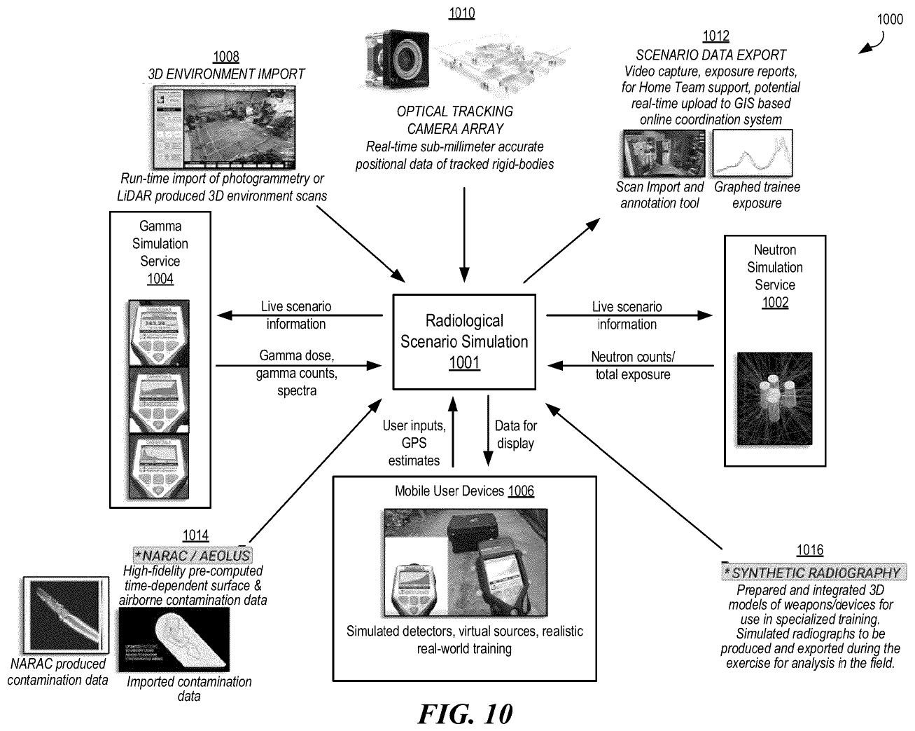

FIG. 10 illustrates a diagram of a simulation system 1000 that includes at least five components. First is the radiological scenario simulation 1001 (e.g., executed by a main simulation engine or module) that receives the optical tracking data, and manages the communication/data flow between the neutron simulation service 1002 and the gamma calculation service 1004, and the connected mobile user devices 1006 that are functioning as simulated detectors. The fact that all the assets positions (source, detector, trainees, walls/partitions) are known and tracked in the system, the radiological scenario simulation 1001 can easily compute a list of intervening layers (thickness, material type) using ray casting techniques to inform the gamma calculation service 1004 for greater realism.

Another component is the gamma calculation service 1004 which is optimized for calculation performance. In some embodiments, the gamma calculation service 1004 provides options to the radiological scenario simulation 1001 that tailors gamma simulation data for increased efficiency. In some embodiments, the gamma calculation service 1004 includes a Geiger-Muller (GM) Tube detector option that will simulate detector performance once it has entered an overload state (which for the R400 detector occurs when the field is greater than 1R/hour).

Another component is the neutron simulation service 1002. A real-time neutron simulation tool that updates the position and orientation of detectors, people, objects, and neutron sources, and provides neutron dose and detection rate information. The objects in the environment are provided to the simulation on a 1 to 2 second rate by the radiological scenario simulation 1001. The simulation primarily accelerates particle-wise tracking (e.g., Monte Carlo approaches) for neutron transport using example techniques described herein for real-time neutron simulation results. The neutron simulation service 1002 can continuously calculate the number of particles that can be simulated in a real-time window (e.g., one second) based on previous runs, and then extrapolate the run to the true source rate. The neutron simulation service 1002 artificially enlarges detection volume in the simulation and applies a correction to obtain true geometric efficiency. As a part of this, the neutron simulation service 1002 accounts for near-field effects and have a correction factor for it. For scattering media, the neutron simulation service 1002 samples precomputed empirical outputs to determine the probability of scattering back into the environment and the energy loss of the neutrons. For neutron multiplication of nuclear material, the neutron simulation service 1002 samples a fission model (e.g., a deterministic point kinetics distribution, an empirical model) to determine the number of neutrons released in a multiplying fission chain. The multiplication of the bare object defined by user-input, and updated as scattering media change the neutronics in the environment.

Another component is the optical tracking solution 1010 (known as motion capture). In some embodiments, the optical tracking solution 1010 is the 120 to 360 fps (frames per second) sub-millimeter accurate tracking technologies that allows the radiological scenario simulation 1001 to provide a realistic simulation in both small rooms and warehouse sized spaces. Using a small 8 camera tracking array it is possible to tracking a number of marked assets in a 30×30 ft area. If more tracking area is needed, the optical tracking solution 1010 can incorporate more cameras or other visual sensors (e.g., light detection and ranging (LiDAR) sensors, radar sensors, infrared cameras) in a modular manner.

Another component of the simulation system 1000 is the use of mobile user devices 1006 as wireless compute units that display simulated real-world detector user interfaces. The mobile user devices include GPS subsystems that allow the radiological scenario simulation 1001 to continue to provide gamma and neutron exposure calculations beyond the optical tracking range if used within a non-GPS-denied space and if the mobile user devices 1006 remain communicatively coupled with the radiological scenario simulation 1001 (in particular, with the computing system executing the radiological scenario simulation 1001).

As illustrated, the simulation system 1000 can further include a 3D environment import 1008 that can collect environmental parameters and a scenario data export 1012. With the scenario data export 1012, performance data and other metrics can be provided to connected devices from which other users (e.g., administrators, supervisors) can monitor the radiological scenario simulation 1001. In some embodiments, the simulation system 1000 includes a contamination service 1014 and a radiography 1016 to further enhance realism and immersion of the radiological scenario simulation 1001.

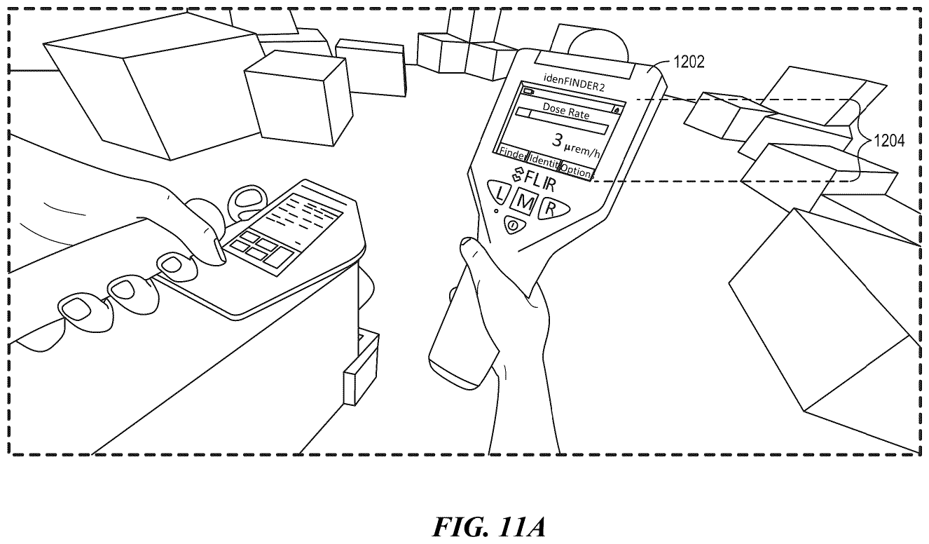

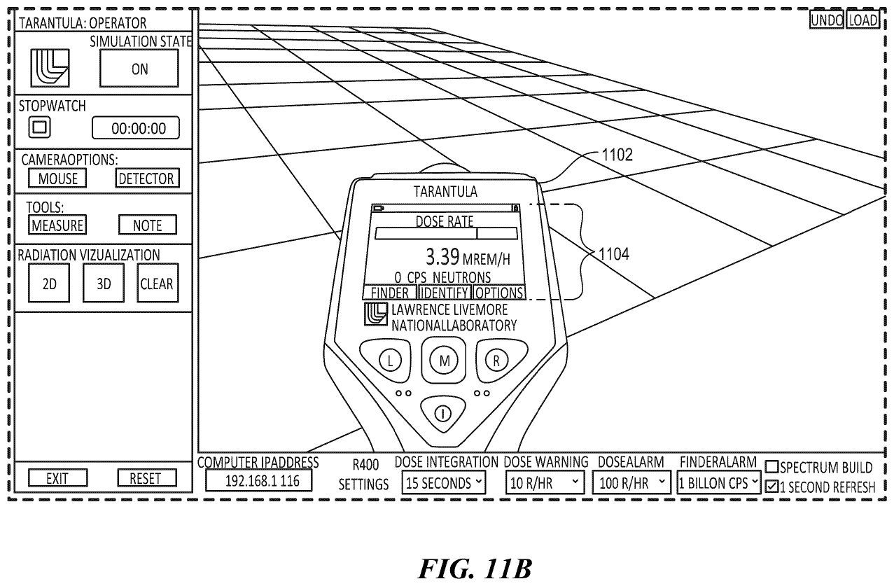

FIGS. 11A and 11B show example views of a radiological scenario simulation provided by an example system. As illustrated, the radiological scenario simulation can be provided in a virtual XR environment in which a user can use a detector object 1102 (e.g., a virtual object corresponding to a physical object being manipulated by the user in the real world, such as a mobile user device 1006). In some embodiments, the radiological scenario simulation obtains real-time simulated neutron and gamma detection data from a neutron simulation module and a gamma simulation module, and the detection data 1104 is displayed with the detector object 1102 within the radiological scenario simulation.

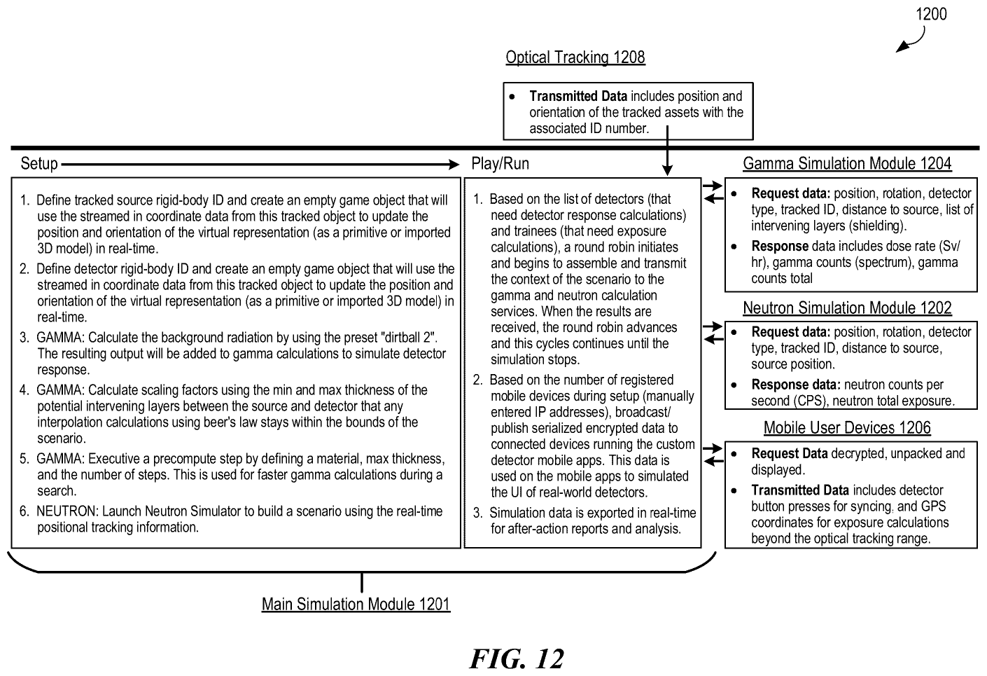

FIG. 12 illustrates a diagram describing example operations performed by a simulation system 1200 and the components thereof, including a main simulation module 1201, a neutron simulation module 1202, a gamma simulation module 1204, mobile user devices 1206, and an optical tracking system 1208. In some embodiments, the example operations are implemented and performed by one or more computing systems. For example, the example operations for the main simulation module 1201, the gamma simulation module 1204, and the neutron simulation module 1202 can be performed by a computing system (e.g., a workstation, a laptop computer, a desktop computer, a distributed computing cluster, a cloud computing platform). In some embodiments, the gamma simulation module 1204 and/or the neutron simulation module 1202 are implemented at different computing systems from the main simulation module 1201. In some embodiments, an initialization operation performed within the simulation system 1200 includes aligning a spatial orientation used by the main simulation module 1201 and other modules (e.g., the neutron simulation module 1202). Aligning the spatial orientation can include defining a rotation orientation.

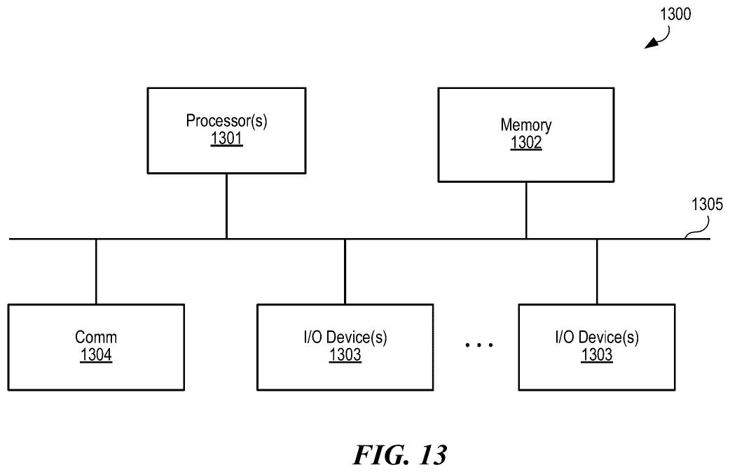

FIG. 13 is a block diagram illustrating an example of a computer system 1300 in which at least some embodiments introduced here can be implemented. For example, the neutron simulation module, the gamma simulation module, and/or the main simulation module can be implemented as hardwired circuitry, or appropriately programmed programmable circuitry, or a combination thereof, in the computer system 1300.

The computer system 1300 includes one or more processors 1301, one or more memories 1302, one or more input/output (I/O) devices 1303, and one or more communication interfaces 1304, all connected to each other through an interconnect 1305. The processor(s) 1301 control the overall operation of the computer system 1300, including controlling its constituent components. The processor(s) 1301 may be or include one or more conventional microprocessors, programmable logic devices (PLDs), field programmable gate arrays (FPGAs), application-specific integrated circuits (ASICs), etc. The one or more memories 1302 store data and executable instructions (e.g., software and/or firmware), which may include software and/or firmware for performing the techniques introduced above. The one or more memories 1302 may be or include any of various forms of random access memory (RAM), read-only memory (ROM), volatile memory, nonvolatile memory, or any combination thereof. For example, the one or more memories 1302 may be or include dynamic RAM (DRAM), static RAM (SDRAM), flash memory, one or more disk-based hard drives, etc. The I/O devices 1303 provide access to the computer system 1300 by human user, and may be or include, for example, a display monitor, audio speaker, keyboard, touch screen, mouse, microphone, trackball, etc. The communications interface 1304 enables the computer system 1300 to communicate with one or more external devices (e.g., an SLM scanner) via a network connection and/or direct connection. The communications interface 1304 may be or include, for example, a Wi-Fi adapter, Bluetooth adapter, Ethernet adapter, Universal Serial Bus (USB) adapter, or the like. The interconnect 1305 may be or include, for example, one or more buses, bridges or adapters, such as a system bus, peripheral component interconnect (PCI) bus, PCI extended (PCI-X) bus, USB, or the like.

Unless contrary to physical possibility, it is envisioned that (i) the methods/steps described herein may be performed in any sequence and/or in any combination, and that (ii) the components of respective embodiments may be combined in any manner.

The machine-implemented computational and control operations described above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for simulation of neutron behavior, the method comprising:
generating, by a processor of a simulation system, a plurality of neutron interaction models for a set of objects of a target environment, a given neutron interaction model of the plurality of neutron interaction models providing a resultant behavior of an incident neutron with a respective object based on expected interactions between the incident neutron and an internal volume of the respective object,
wherein the set of objects includes environmental objects, a person, a detector object, and a radiation source object;
performing, by the processor, a Monte Carlo simulation in which a particular number of neutron particles originate from the radiation source object and interact with the set of objects according to the neutron interaction models and spatial data that specifies locations of the set of objects within the target environment,
wherein the particular number is less than a specified number of neutron particles associated with the radiation source object by a first scaling factor, and
wherein performing the Monte Carlo simulation includes increasing a simulated size of the detector object by a second scaling factor such that an increased amount of neutron particles interact with the detector object in the Monte Carlo simulation;
calculating, by the processor, dosage data for the person and detection data for the detector object via the Monte Carlo simulation, wherein each of the dosage data and the detection data is adjusted from a simulation output data according to the first scaling factor, and wherein the detection data is further adjusted from the simulation output data according to the second scaling factor; and
providing, by the processor, the dosage data and the detection data to a main simulation engine that provides an interactive extended reality (XR) simulation with the set of objects within the target environment.

2. The method of claim 1, further comprising:
providing, by the processor, the dosage data and the detection data to a gamma simulation system that is configured to provide gamma simulation data to the main simulation engine for the interactive XR simulation.

3. The method of claim 1, further comprising:
predicting, by the processor, an optimized number of neutron particles for a second Monte Carlo simulation based on a duration of the Monte Carlo simulation; and
in response to a command from the main simulation engine, performing, by the processor, the second Monte Carlo simulation with the optimized number of neutron particles to obtain second dosage data and second detection data for the main simulation engine.

4. The method of claim 1, wherein performing the Monte Carlo simulation comprises:
simulating an increasing number of neutron particles until a simulation time has expired, wherein the particular number of neutron particles is a maximum of the increasing number of neutron particles before the specific simulation time expired.

5. The method of claim 1, further comprising:
implementing, by the processor, a fission chain model that samples a number of neutrons that scatter back into the radiation source object during the Monte Carlo simulation;
determining, by the processor, source behavior data that includes a fission likelihood using the fission chain model during the Monte Carlo simulation; and
providing, by the processor, the source behavior data to the main simulation engine for the interactive XR simulation.

6. The method of claim 1, wherein the neutron interaction models includes a directional efficiency model specific to the detector object, and wherein the detection data for the detector object is calculated via the directional efficiency model and incident directions of neutron particles with the detector object provided by the Monte Carlo simulation.

7. The method of claim 6, further comprising:
generating a first histogram of neutrons that are incident on the detector according to energy;
generating a second histogram of the neutrons that are incident on the detector according to direction; and
evaluating the first histogram and the second histogram using the directional efficiency model to determine the detection data for the detector object.

8. The method of claim 1, further comprising:
receiving, by the processor, a second spatial data for the target environment from the main simulation engine, the second spatial data specifying second locations for the set of objects based on a camera-based tracking of the set of objects within the target environment; and
performing, by the processor, a second Monte Carlo simulation in which the neutron interaction models are applied at the second locations specified by the second spatial data.

9. A system for simulating radiation in a target environment, the system comprising:
a main simulation module configured to dynamically generate spatial data for a set of objects in a target environment;
a neutron module configured to:
perform a particle-wise simulation of a particular number of virtual neutron particles within the target environment using empirical interaction models for the set of objects according to the spatial data dynamically generated by the main simulation module, and
provide output data from the particle-wise simulation to the main simulation module; and
a gamma module configured to simulate gamma ray interactions for a set of objects in a target environment.

10. The system of claim 9, wherein the particular number of virtual neutron particles is one of: (i) a pre-determined number of virtual particles that the neutron module predicts is able to be simulated by the neutron module within a time limit, or (ii) a maximum number of virtual neutron particles that the neutron module completes during the particle-wise simulation prior to the time limit elapsing.

11. The system of claim 9, wherein the particular number of virtual neutron particles is less than a specified number of neutron particles for the particle-wise simulation by a first scaling factor, and wherein the neutron module is further configured to:
determine the output data from the particle-wise simulation based on scaling simulated measurements by the first scaling factor.

12. The system of claim 9, wherein the output data from the particle-wise simulation includes (i) dosage data for people objects of the set of objects and (ii) detection data for a detector object of the set of objects, wherein the detection data is determined based on precomputing a directional efficiency model for the detector object and using the directional efficiency model for certain virtual neutron particles simulated to interact with the detector object within the target environment.

13. The system of claim 9, wherein the main simulation module is further configured to:
receive the output data from the particle-wise simulation from the neutron module, wherein the output data includes neutron detection data that describes a count of the virtual neutron particles in the simulation that are detectable by a detector object of the set of objects;
receive gamma detection data that is determined by the gamma module based on the neutron detection data being provided to the gamma module, the gamma detection data describing neutron-induced gamma rays that are detectable by the detector object; and
causing the neutron detection data and the gamma detection data to be displayed with a virtual XR representation of the detector object provided to a user.

14. The system of claim 9, wherein the set of objects includes a source object from which the virtual neutron particles originate in the particle-wise simulation, and wherein performing the particle-wise simulation includes:
using a fission model to determine source object behavior in response to scattering of the virtual neutron particles back into the source object, wherein the output data from the particle-wise simulation includes source behavior data that describes the source object behavior.

15. The system of claim 14, wherein the main simulation module is configured to provide the source behavior data to the gamma module, and wherein the gamma module is configured to, using the source behavior data, generate gamma fission data describing gamma rays induced by the source object behavior.

16. The system of claim 9, wherein the neutron module is further configured to:
generate the empirical interaction models for the set of objects, the set of objects being specified by the main simulation module to the neutron module prior to the particle-wise simulation.

17. The system of claim 9, wherein the main simulation module is configured to dynamically generate the spatial data based on tracking an object of the set of objects across visual data collected by a plurality of visual sensors located within the target environment.

18. The system of claim 9, wherein the gamma module is further configured to automatically generate a map of the set of objects in the target environment, wherein the gamma module uses the map to simulate the gamma ray interactions with the set of objects.

19. The system of claim 9, wherein the gamma module is configured to simulate the gamma ray interactions based on using a matrix approximation technique to accelerate simulation of gamma ray transport.

20. A computing system comprising:
at least one processor; and
at least one memory accessible to the at least one processor and storing instructions, execution of which by the at least one processor causes the computing system to:
obtain a plurality of precomputed models for a plurality of objects included in a radiation scenario simulation within a target environment, wherein each precomputed model of the plurality of precomputed models describes resultant behavior of a neutron particle incident on a respective object;
perform a simulation run that simulates the resultant behavior of a particular number of virtual neutron particles by using the plurality of precomputed models in combination with spatial data that describes current locations of the objects within the target environment,
determine virtual detection data for a detector object of the plurality of objects based on the simulation run; and
execute the radiation scenario simulation based on the virtual detection data.

21. The computing system of claim 18, wherein execution of the instructions further causes the computing system to:
determine the particular number of virtual neutron particles according to a predicted computing capability based on a previous simulation run before the simulation run; and
scaling the virtual detection data according to a scaling factor between the particular number of virtual neutron particles and a specified number of virtual neutron particles received by the computing system.

22. The computing system of claim 18, wherein the virtual detection data is determined based on a scaling factor applied on a volume of the detector object during the simulation run.

23. The computing system of claim 19, wherein performing the simulation run includes:
for each virtual neutron particle that is incident on the detector object according to the spatial data, determine whether to tally the virtual neutron particle based on randomly evaluating a probability corresponding to the scaling factor, wherein the virtual detection data is based on a total tally of virtual neutron particles.

24. The computing system of claim 18, wherein at least some of the objects included in the radiation scenario simulation are virtual objects, and wherein the radiation scenario simulation and the virtual objects are provided via an XR display system to a user.

25. The computing system of claim 18, wherein the instructions cause the computing system to:
determine fission behavior data of a virtual source object included in the radiation scenario simulation, wherein the fission behavior data is determined using a particular precomputed model for the virtual source object that samples a count of additional neutron particles expected to be released by the virtual source object in response to a given virtual neutron particle being scattered back into the virtual source object; and
provide the fission behavior data for display with the radiation scenario simulation.
